(19) United States
(12) Patent Application Publication
(10) Pub. No.: US 2008/0005235 A1
(43) Pub. Date: Jan. 3, 2008

(54) COLLABORATIVE INTEGRATED DEVELOPMENT ENVIRONMENT USING PRESENCE INFORMATION

(75) Inventors: Rajesh Hegde, Redmond, WA (US); Prasun Dewan, Chapel Hill, NC (US); Yong Rui, Sammamish, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/428,080

(22) Filed: Jun. 30, 2006

(51) Int. Cl. G06F 15/16

(52) U.S. Cl. 709/204

(57) ABSTRACT

A system and process for providing a network and computer-based integrated development environment is presented that provides collaboration and information sharing for development project team members. Generally, this is accomplished by integrating a presence and activity awareness information module, a collaboration tools module, and a user interface into a single environment that is accessible over a distributed network and serves as a virtual development complex. The information module continuously collects, monitors and analyzes information about the presence of each team member and their activity in the project. The tools module provides a wide range of facilities for synchronous and asynchronous collaboration and information sharing between team members. Thus, all team members who use the virtual complex for their development work on the project can collaborate and interactively share required information regardless of their geographic and/or temporal disparity, and without having to leave the virtual development complex.

### BACKGROUND

Companies who develop products are always facing the challenges of providing a higher volume of new products, with higher levels of complexity and higher quality, in a shorter time frame, and with smaller budgets and fewer people. Similar challenges can face companies and other teams of people who work together to complete any sort of development project, including those that are not product related (such as a company developing their own information technology system or infrastructure, among many others). These challenges are compounded by the fact that a typical team of people that is responsible for completing a development project (hereinafter termed a project team) is often geographically and/or temporally dispersed, and includes team members who reside at different locations working at different times of the day. By way of example, many companies have offices and staff located in different parts of the country and in other countries throughout the world. This geographic and temporal project team distribution is further compounded by the growing corporate trend towards off-shore development and outsourcing. In addition, there is a growing trend for companies to allow team members to work from home, an activity termed “telecommuting.”

It is generally understood that an effective way for project teams to address the different development project challenges outlined above, and hence improve the productivity of a geographically and/or temporally dispersed team and the quality of the resulting product they develop (or other end result of their development project), is to foster an increase in collaboration and related effective communication among all the members of the project team—regardless of where they are located and if their work hours overlap or not with other team members. However, collaboration among team members is often difficult to achieve, even for a team that is co-located. A fundamental reason for this is that, even though the benefits of collaboration to the overall project are generally understood by the team, some team members are resistant to participating in collaboration activities since they feel it distracts them from their own, primary project responsibilities—which are completing their assigned development tasks. For a team that is not co-located, the difficulties in achieving collaboration are compounded due to various communication barriers stemming from the team's geographic and/or temporal disparity. In addition, the collaboration tools generally available to a project team are typically inefficient and cumbersome to use, and hence are typically ineffective. Thus, collaboration between members of a non-co-located, dispersed project team is generally much lower (in terms of quantity, quality, functionality and effectiveness) than between members of a co-located team. This in turn has a negative impact on the productivity of the whole team and the quality of the product they develop (or other end result of their development project).

Communication network and computer-based integrated development environment (IDE) tools (hereinafter referred to as network and computer-based IDE tools or simply IDE tools) exist today that operate across a network in a distributed fashion on each team member's computer. However, these existing tools have several shortcomings which prevent their ability to address the collaboration and related communication needs of geographically and/or temporally dispersed project teams.

The first shortcoming of existing IDE tools is that the frequency of “unintended interactions” is reduced for dispersed team members. Unintended interactions are ad hoc interactions which arise from team members' serendipitous meetings—these are crucial for optimal collaboration on, and communication of, regularly changing project status, issues and other developments. In addition, the content of these interactions, when and if they do occur, is substantially degraded because existing IDE tools lack real-time, detailed, project and team-specific “presence” information integrated directly within the IDE tool. This required presence information includes, by way of example, detailed real-time data related to each member of the project team, their work status, the tasks they may be involved in, the source files they may be working on, and more specific information regarding the work they are doing within the source files. Such detailed presence information allows team members to better coordinate their work.

The aforementioned presence information is crucial to enabling effective collaboration between team members, especially because it is the foundation for unintended interactions. Most existing systems or tools for distributed collaboration provide presence information that is too vague and not very useful. For example, one popular tool for on-line collaboration used by distributed team members is instant messaging. Unfortunately, current instant messaging systems only indicate whether a team member is online or away from their computer. In addition, most of this presence data needs to be set manually by the team member (rather than being detected automatically), and hence, is prone to being incorrect. In addition, a team member who is on their computer but not currently working on the development project, may not want to be disturbed by a development project collaboration activity such as being invited to a team discussion.

A second shortcoming of existing IDE tools that further reduces the frequency and degrades the content of unintended interactions is that they lack convenient-to-use, “light-weight,” interactive communication features which are required to support effective and efficient audio and visual collaboration and data sharing between geographically dispersed team members. Light-weight in this context means that the features are very easy for team members to instantiate and they require only a small amount of incremental computing resources, hence, motivating team members to regularly use the features.

While communication tools exist today that attempt to provide support for some of the presence information and collaboration feature needs described above, there exists no IDE tool that incorporates all these features directly from (i.e., integrated) within the IDE itself. Furthermore, the presence information provided in existing IDE tools is not intended to facilitate ad hoc collaboration and therefore is not very detailed. As a result, in order to access the presence information and collaboration functionality, project team members have to move out of the IDE and into a separate environment established by a different, non-integrated tool. For example, project team members need to use separate, non-integrated email or instant messaging tools to collaborate with other team members and this collaboration may be limited to being non-real-time since a team member does not have access to the real-time presence information associated with another team member he wants to collaborate with. The cost to the team member of this “context switch,” and the overhead associated with their having to manage and transition back and forth between multiple tool environments, is significant in terms of its hampering the effectiveness and productivity of their collaboration with other team members and reducing their focus and productivity on their primary initiative, which is working inside of the IDE to successfully complete their assigned development tasks.

It should be noted that, while specific shortcomings and disadvantages of existing IDE tools are described above, the subject matter claimed below is not limited to implementations that solve any or all of these shortcomings and disadvantages.

### SUMMARY

The present invention is directed toward a system and process for providing an interactive, network and computer-based integrated development environment (IDE) that increases collaboration and improves the effectiveness of project-related communication for all the members of a geographically and/or temporally dispersed development project team (i.e., a team whose members reside at different locations and may work at different times of the day). This is achieved by overcoming the obstacles presented by communication barriers stemming from the geographic and temporal disparity of the different, non-co-located team members. This is further achieved by addressing the shortcomings of existing IDE tools.

More particularly, the present invention is embodied in a system and process for providing an interactive, network and computer-based IDE that results in the aforementioned increases in collaboration and improvements in communication by integrating real-time, detailed presence information and activity awareness information directly into the IDE. By way of example but not limitation, this presence and activity awareness information consists of data on each member of the development team, the specific project items they are assigned to develop or other tasks they are assigned to complete, source files they create in the course of their development work, and more specific information regarding the work they do within the source files. By way of further example but not limitation, this includes data such as: which team members are currently available (i.e., which are working on the project), how they can be contacted, what items and/or tasks they still have pending and which have already been completed, what items and/or tasks are assigned to other team members, if they are available to be interrupted for collaboration with other team members or not, and what types of collaboration activities are currently going on and who is involved. This also includes data such as what item or task in the project each team member is currently working on and how the work they are currently doing may conflict with the work of others, among other things. This ability to detect conflicting work saves time and hence, improves the efficiency of the project team by automatically alerting team members to potential issues in their work and giving them a chance to address the issues before they are subsequently found when their work is submitted into the IDE or in subsequent testing—which would thus require the more time intensive effort of debugging the issues later in the project.

The presence and activity awareness information covers the following five general categories of data:
1. “People Presence Data”—This generally relates to various types of information about each person on the project team and their availability.
2. “Session Presence Data”—This generally relates to various types of information about the different collaboration sessions (i.e., network and computer-based meetings and other interaction between team members) that take place during the course of the development project.
3. “Project Presence Data”—This generally relates to various types of information about all the different tasks and sub-projects that make up the overall development project.
4. “Work Item Presence Data”—This generally relates to various types of information about the different “work items” that result from the development activities of the different project team members, and also includes the source files (hereinafter also referred to as work files) for each item being developed if applicable.
5. “Contacts Data”—This generally relates to a list of project team contacts containing information such as who is assigned to work on which aspects of the project and who has expertise in which areas and/or topics, among other things. This information is automatically and dynamically updated based on changes in the information contained in the other categories as well as information mined from the network.

Furthermore, the present invention is embodied in a system and process for providing an interactive, network and computer-based IDE that increases collaboration and improves the effectiveness of project-related communication for all the members of a geographically and/or temporally dispersed product development project team by integrating interactive collaboration tools directly into the IDE. These collaboration tools are convenient-to-use, light-weight, and provide the interactive communication required for effective and efficient audio and visual collaboration, and data sharing, between geographically dispersed project team members. As such, these integrated tools further optimize the collaboration among all members of the project team. By way of example but not limitation, the types of real-time collaboration supported by these tools includes, among other things, both synchronous and asynchronous (i.e., store-and-forward) communication and information sharing via: 1. text-based messaging; 2. live (i.e., real-time) “electronic whiteboard” (i.e., a network and computer-based functional equivalent of a chalk board); 3. audio/video conferencing; 4. joint browsing and peer review of work items (also herein termed co-browsing); 5. joint debugging of work items (another form of co-browsing); and 6. annotation of work items.

The combination of the aforementioned presence information, activity awareness information and collaboration tools that are integrated into the IDE system and process provided by the present invention results in an increase and improvement in the quantity, quality, functionality and effectiveness of collaboration among all members of the project team, regardless of their geographic and/or temporal disparity. As a further result, the productivity of the team as a whole and the overall quality of the product they develop (or other end result of their development project) are also improved, again regardless of the geographic and/or temporal disparity of the team. However, these results are especially true for a geographically and/or temporally dispersed (i.e., not co-located) project team including one in which some team members telecommute.

It should be noted that this Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. In addition to the just described benefits, other advantages of the present invention will become apparent from the detailed description which follows hereinafter when taken in conjunction with the drawing figures which accompany it.

### DESCRIPTION OF THE DRAWINGS

The specific features, aspects, and advantages of the present invention will become better understood with regard to the following description, appended claims, and accompanying drawings where:

FIG. 1 shows a diagram of a general purpose, network-based computing device constituting an exemplary system for implementing the present invention.

FIG. 2 shows a diagram of an exemplary architecture for implementing the present invention.

FIG. 3 shows an exemplary graphical user interface (GUI) layout according to the present invention.

FIG. 4 shows an exemplary view of a GUI used to display presence and activity information inside the presence sector of FIG. 3.

FIG. 5 shows an exemplary view of a GUI and related pop-up sector, also displayed inside the presence sector of FIG. 3, used to either determine more detail about the current activities of another user or to initiate a collaboration session with another user.

FIG. 6 shows an exemplary view of a GUI and related, subsequent pop-up sector, also displayed inside the presence sector of FIG. 3, containing more detailed information on the current activities of another user.

FIG. 7 shows an exemplary view of a pop-up GUI sector, also displayed inside the presence sector of FIG. 3, containing information related to which users currently have a particular file “checked-out” (i.e., they have possession of the file), and the last “N” users who previously checked it out or checked it in (i.e., they relinquished possession of the file).

FIG. 8 shows an exemplary view of a GUI, also displayed inside the presence sector of FIG. 3, containing information related to a conflict between the work two users are concurrently doing.

FIG. 9 shows an exemplary view of a GUI, also displayed inside the presence sector of FIG. 3, containing information and interactive controls associated with an audio/video conference collaboration session.

FIG. 10 shows an exemplary view of a GUI, displayed inside the video sector of FIG. 3, containing the videos for each user in an audio/video conference collaboration session.

FIG. 11 shows an exemplary view of a GUI, displayed inside the text chat sector of FIG. 3, containing information and interactive controls associated with a text chat collaboration session.

FIG. 12 shows an exemplary view of a GUI containing information and interactive controls associated with application program sharing.

FIG. 13 shows an exemplary flow diagram depicting a process for monitoring the presence and activity of each user, detecting changes in the presence and activity, and updating the presence and activity awareness information based on the changes.

FIG. 14 shows an exemplary flow diagram depicting a process for monitoring activity associated with work items and associated work files according to the present invention.

FIGS. 15A-B show an exemplary flow diagram depicting a process for monitoring which users using the present invention have possession of which work files and their associated independent activity on the files, comparing and analyzing the activity for conflicts, and informing users using the present invention of activity conflicts.

### DETAILED DESCRIPTION

In the following description of embodiments of the present invention reference is made to the accompanying drawings which form a part hereof, and in which are shown, by way of illustration, specific embodiments in which the invention may be practiced. It is understood that other embodiments may be utilized and structural changes may be made without departing from the scope of the present invention. For example, herein a software development project is used as the basis to describe the practice of the embodiments of the present invention. However, as discussed below, the present invention is equally applicable to, and may also be practiced in, other types of development projects as well.

Herein the term “sector” is used to refer to a segmented region of a computer display device, such as a monitor among other things, in which a particular type of graphical user interface (GUI) or information is displayed, or a particular type of function is performed.

### 1.0 The Computing Environment

Before providing a description of the preferred embodiments of the present invention, a brief, general description of a suitable communication network and computing environment in which the invention may be implemented will be described. This environment provides the foundation upon which the preferred embodiments of the present invention operate.

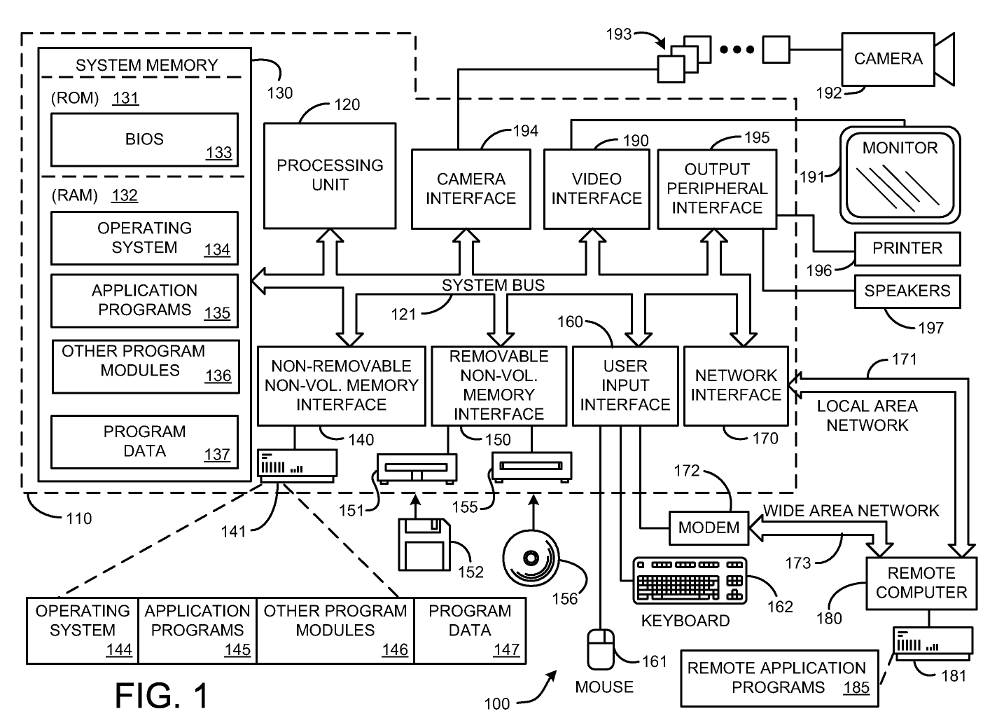

FIG. 1 illustrates an example of a suitable computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include items such as routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195. An audio/video (A/V) capture device 192 can also be included as an input device to the personal computer 110. The A/V output from the device 192 is input into the computer 110 via an appropriate AN interface 194. This interface 194 is connected to the system bus 121, thereby allowing the images to be routed to and stored in the RAM 132, or one of the other data storage devices associated with the computer 110.

The computer 110 operates in a networked environment using logical connections to communicate with one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### 2.0 The Collaborative Integrated Development Environment

The present collaborative integrated development environment (IDE) system and process combines real-time, detailed presence information, activity awareness information and convenient-to-use, light-weight, interactive collaboration tools into a single environment that serves as a virtual development complex. The IDE system and process operates over a communication network (such as an intranet or the Internet) in a distributed fashion on each project team member's computer. All members of the project team perform their development activities using the IDE system and process. Everything team members require to complete the project (including, by way of example but not limitation, information, tools, and collaboration with others) is available to them within the virtual development complex provided by the IDE system and process. The IDE system and process also provides for various forms of synchronous collaboration (in addition to asynchronous collaboration).

The frequency of unintended interactions between all team members is increased because all team members working in the IDE system have ready access to detailed, real-time, automatically-updated people presence data and related activity awareness associated with all other team members. The content, effectiveness and efficiency of these unintended interactions is improved because all team members working in the IDE system also have ready access to detailed, real-time, automatically-updated project presence data, session presence data, work item presence data, related activity awareness and contacts data that reflects the current state of the entire project and all the different development activities and people associated with the project.

The frequency, content, effectiveness and efficiency of unintended interactions between all team members are further improved because the IDE system and process contains integrated, convenient-to-use, light-weight, audio and visual collaboration tools which facilitate improved interactive communication and project data sharing among all members of the project team, regardless of their physical location. The fact that these tools are contained directly within the IDE system and process, combined with the fact that they are integrated with the aforementioned various types of presence and activity awareness data, improves the usability and efficiency of the collaboration tools, and hence the quality and effectiveness of the resulting collaboration among team members. By way of example but not limitation, reasons for these improvements include the fact that team members no longer have to make context switches back and forth between the IDE and a separate, non-integrated communication tool such as email or instant messaging—therefore, they achieve improved focus and productivity on their primary initiative which is to successfully complete their project development work inside the IDE. Additionally, regardless of their geographic distribution, team members can now engage in real-time, interactive collaboration that may include the sharing of various types of project data or files as necessary to optimally achieve the objectives of the collaboration.

Overall, the IDE system and process provides for an increase in collaboration (in terms of quantity, quality, functionality and effectiveness) and an improvement in the effectiveness of project-related communication for all members of the project team, even if they are geographically and/or temporally dispersed (i.e. they reside at different locations and/or may be working at a time of the day which is different from other team members). As an end result, the IDE system and process provides for an improvement in the productivity of the project team as a whole and the overall quality of the product they develop (or other end result of their development project).

### 2.1 Example Project

A software development project is used hereinafter as the example development project for the purpose of providing a detailed description of the system architecture and GUI associated with one embodiment of the present invention. In a typical software development project the software design is architected into modules, each module performing a particular set of functions related to the overall functionality of the product. Project team members are assigned responsibility to develop software code that implements the functionality for each of the modules. Hence, in this development project context the “work items” are, by way of example but not limitation, software code modules and corresponding documentation files, among other things.

In the development process team members write software code, compile and build the code, test and debug the code, and submit their code to a common source code control system (SCCS)—this process of submitting code into an SCCS is commonly termed “checking in” the code in the art of software development. In addition, in a project team that is optimally collaborating, often times software code developed by one team member needs to be reviewed by other team members or a manager before the code gets submitted into the SCCS for testing and use by the rest of the project. Further, at times a team member will need help understanding someone else's code or another aspect of the project but does not know the right person to contact. At other times, multiple team members may unknowingly be working on the same code module, the same class or function, or dependent classes or functions at the same time which can cause significant problems when, for example, the changes made by one person conflict with those made by another person. Existing IDE tools do not provide the required facilities or activity awareness to handle these collaborative tasks from within the tool environment itself. This results in the aforementioned project and team problems and issues. The collaborative IDE system and process embodied in the present invention does provide the required facilities and activity awareness to handle (i.e., enable) the aforementioned collaborative tasks, along with others, from directly within the IDE itself.

### 2.2 System Architecture

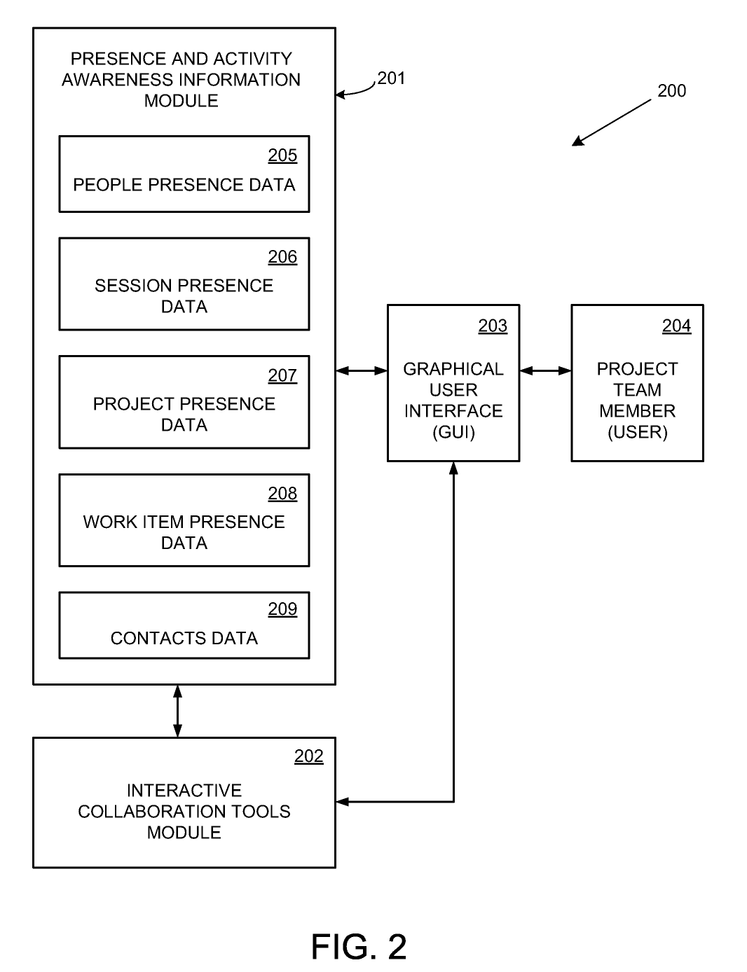

FIG. 2 shows a diagram of an exemplary architecture 200 for implementing the present collaborative IDE system and process. Each of the aforementioned results is accomplished by integrating a presence and activity awareness information module 201 with interactive collaboration tools 202 and a GUI 203. A prospective user 204 of the system and process gains access by logging into the system via the GUI 203. A development project team member 204 who successfully logs into the system via the GUI 203 is termed an “authorized” team member, hereinafter also termed an “authorized user” or simply a “user.” The presence and activity awareness information module 201 contains real-time, detailed, automatically updated information associated with the following different categories of project-related data: people presence 205, session presence 206, project presence 207, work item presence 208 and contacts 209. It should be stressed that, in contrast to existing IDE tools, this presence information is very detailed. Furthermore, in the example project used herein, said presence information is specific to software development. The IDE system and process continuously monitors, via network-distributed polling of all computers in the system, the current work status and the details of the particular current activities of each user 204, dynamically detects changes in their work status and activities, and automatically updates the data in the information module 201 as necessary. The GUI 203 presents the data, tools, and related interactive user controls and data entry capabilities corresponding to these integrated elements, to each user.

### 2.3 People Presence Data

The people presence data category 205 contains various data associated with each user 204. By way of example but not limitation, this includes: 1. If the user is currently working on the project or not (i.e., if they are online or offline with regard to the IDE system and process, or similarly, if they are logged into or not logged into the IDE system and process); 2. If they are working on the project, then if they are busy or idle at the moment, and if they are busy, which particular activities they are currently involved in (such as, if they are currently viewing or editing a file, typing code associated with a work item, testing and debugging a work item, or are involved in a collaborative session with another user, among other things); 3. The number and types of project tasks they are assigned to complete (such as work item source files and documentation, among other things); and 4. The ways in which they can be contacted (such as email address(es) and phone number(s), among other things). Other forms of data associated with each user and their activities are contained in the other data categories discussed below.

### 2.4 Session Presence Data

The session presence data category 206 contains various data associated with the different collaboration activities that are currently underway between users (i.e., both real-time and non-real-time network and computer-based meetings and other collaborative interaction between users, hereinafter termed sessions). By way of example but not limitation, this includes: 1. The types of sessions that are currently underway; 2. Who the participants are in each session; and 3. If the session is a public one (i.e., the session is open to other users to monitor or join), versus a private one (i.e., the session is closed to other users), facilities for other users to join in the session—in tested embodiments this is implemented via a buddy list, however, it could alternatively be implemented in a different fashion that provides more elaborate security.

### 2.5 Project Presence Data

The project presence data category 207 integrates various forms of data associated with project work-flow and the overall progress of a project from beginning to end into the present IDE system and process. The types of data that may be integrated into this category include, by way or example but not limitation: 1. The number of work items and/or other development project tasks assigned to each project team member; 2. The development status of each work item/task (i.e., pending or completed, among other things); 3. The number of anomalies (also commonly referred to as bugs in product development) found thus far, both per work item and in the project overall; 4. Specific information related to each anomaly (such as which work item it is associated with, who it is assigned to, and if it has been resolved or is still unresolved, among other things); and 5. Various other measures of the status and progress of the overall project may also be included.

### 2.6 Work Item Presence Data

The work item presence data category 208 contains various data associated with the work items and associated work files (such as source code files and documentation files, among other things) that are assigned to, and result from, the development activities of each user 204. By way of example but not limitation, this includes: 1. The work files (such as source code files or documentation files, among other things) associated with each work item; 2. Which work files each user currently has possession of (i.e., has “checked-out” of the SCCS); 3. Which users are currently working on which work files they have possession of; 4. The specific class or function they may be working on within the work files they have possession of; 5. The last “N” changes that were previously made to a work file and who made each one—a user can then view the specific changes that were previously made in the file by other users; 6. Differences between a particular instantiation of a checked-out work file one user currently has possession of and a previously checked-out instantiation of the same work file that another user may concurrently have possession of (i.e., they are independently working on the file and have not yet checked it back into the SCCS)—this is implemented by performing a distributed analysis of the contents of the different versions of the file within the IDE system and process; and 7. How the work a particular user is doing on one work file may conflict with the work of another user (such as, if both users concurrently have possession of and are independently working on the same work file at the same time, and one user changes the signature of a software function while the other user calls the software function).

### 2.7 Contacts Data

The contacts data category 209 leverages, as required, the various data present in the aforementioned other data categories to provide a variety of different contacts-centric (i.e., “go-to” person) views. These views are presented to each user 204 in a fashion similar to a buddy list, and are hereinafter simply referred to as contact lists. Contact lists are constructed via a data mining scheme whereby “objects” related to other “objects” are identified and then assembled into list form. A contact list can be assembled and presented to a user dynamically based on the context or content of what they are currently working on. A contact list can also be assembled on-demand based on a user's identification of keywords such as a topic of interest, among other things. Information contained in a contact list is automatically updated via ongoing, dynamic data mining in data repositories such as the presence and activity awareness information module 201 and other company data repositories like the email system, among others.

By way of example but not limitation, a contact list may contain information such as which users are assigned to work on which aspects of the project. The contact list may also contain, by way of example, information such as who is the best person to contact for a particular project topic (i.e., who has expertise on the topic). This expertise information can be automatically included in the profiles of a group of users invited to a collaborative session. The best person to contact for a particular topic can be determined by different methods, including among others: 1. Identifying users assigned to work on various aspects of the project; 2. Identifying users who changed or are responsible for working on particular files; and 3. Looking at keywords in the topic and performing the aforementioned process of data mining.

### 2.8 Collaboration Tools

The collaboration tools 202 provide the facilities, directly integrated within the IDE system and process, to initiate and execute different types of interactive communication, collaboration and data sharing amongst all users 204. Hence, the collaboration tools 202 operate in a distributed fashion across the network, and utilize and interact with the various elements of the aforementioned data in the presence and activity awareness information module 201. Furthermore, the collaboration tools 202 support both synchronous (i.e., real-time) and asynchronous (i.e., non-real-time or batch) communication and collaboration between users. By way of example but not limitation, the collaboration tools 202 support the following types of interactive sessions between two or more users: 1. Text-based instant messaging (i.e., chatting); 2. Audio conferencing; 3. Audio/video conferencing; 4. Application program sharing; 5. Information sharing and idea “brainstorming” by multiple users via a live (i.e., real-time) “electronic whiteboard” (i.e., a network and computer-based functional equivalent to a chalk board)—this is a specific form of application sharing—in tested embodiments of the IDE system and process only one user at a time has “possession” or “control” of (i.e., can write or erase on) the whiteboard, while the other users can only see it; 6. A shared display region used for joint user browsing (also termed co-browsing) of a file enabling project activities such as, among other things, a peer-based software code review or inspection, or joint debugging by multiple users including the ability for one user to transfer a debugging session to another user—this is particularly useful in situations where a team member is unable to complete the debugging of a problem on their own and needs help from another user; and 7. Annotation of work items (the annotation consisting of methods such as text, graphics and images, among others), including work items being co-browsed—this is termed contextual annotation since it takes place in the context of a co-browsing collaboration session and other team members can see the annotations as they are made. The collaboration tools 202 also include the ability to archive the proceedings and artifacts of the aforementioned various interactive collaborations for future reference, including by way of example but not limitation, archival of chat text, audio, video, electronic whiteboard annotations and file annotations.

### 2.9 Example User Interface

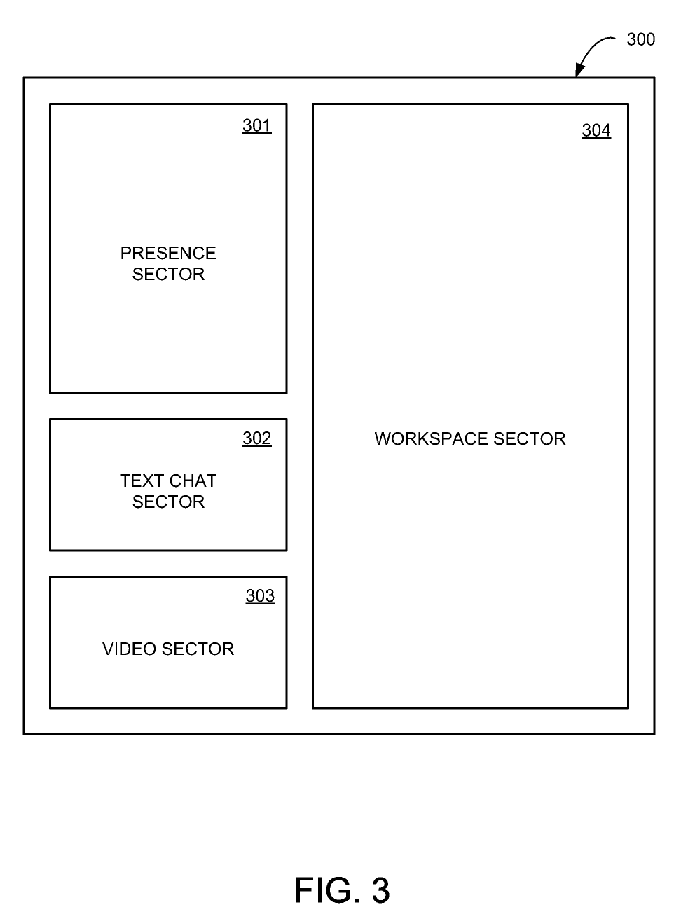

FIG. 3 shows an exemplary layout 300 for the GUI 203 shown in FIG. 2. The layout 300 is used to present the aforementioned presence and activity awareness information, interactive collaboration tools and related user controls to each IDE system and process user. The layout 300 divides the user's computer screen into the following sectors: a presence sector 301, a text chat sector 302, a video sector 303 and a workspace sector 304. These sectors are used to display the various GUIs and associated project data and files described herein. The specific use for each sector will be described herein concurrently with the various GUIs.

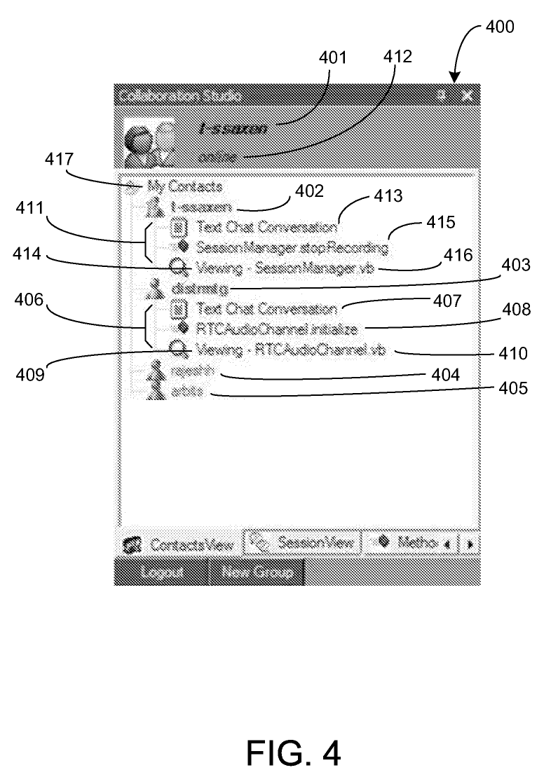

FIG. 4 shows an exemplary view of a GUI 400 used to present a user 401 logged into the IDE system and process with presence and activity information, and associated interactive controls. The GUI 400 is displayed inside the presence sector 301 of the exemplary layout 300 of FIG. 3. Under the my contacts heading 417 the GUI 400 lists the IDs of all the members of the project team (i.e. all the users), starting with the ID of the user himself/herself 402 followed by the IDs of the other users 403/404/405. Via basic information 406 listed under a each user's ID 403, the user 401/402 can determine whether a particular user 403 is currently working on the project (i.e., if they are online or offline with regard to the IDE system and process) and other basic information related to their current activities such as, by way of example but not limitation, which particular activities and/or collaborative sessions they are currently involved in 407/409, and which functions 408 and files 410 they are working on (i.e., the files they have checked-out of the SCCS), if any. Basic work activity information is also displayed for the user himself/herself 401/402 including their current work status 412 and other basic information related to their current activities such as, among other things, which particular activities they are currently involved in 413/414, and which functions 415 and files 416 they are currently working on, if any. The contents of any files a user has checked-out of SCCS and open for viewing or editing are displayed in the workspace sector 304 of the exemplary layout 300 of FIG. 3.

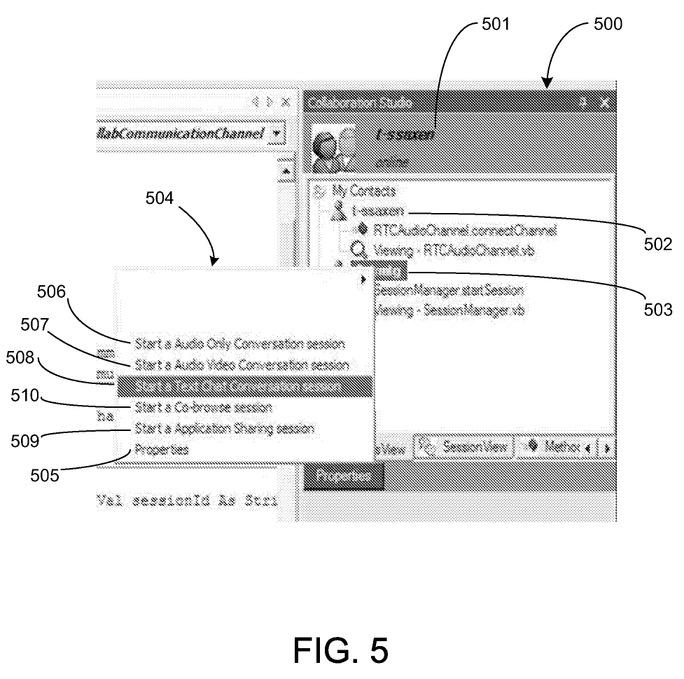

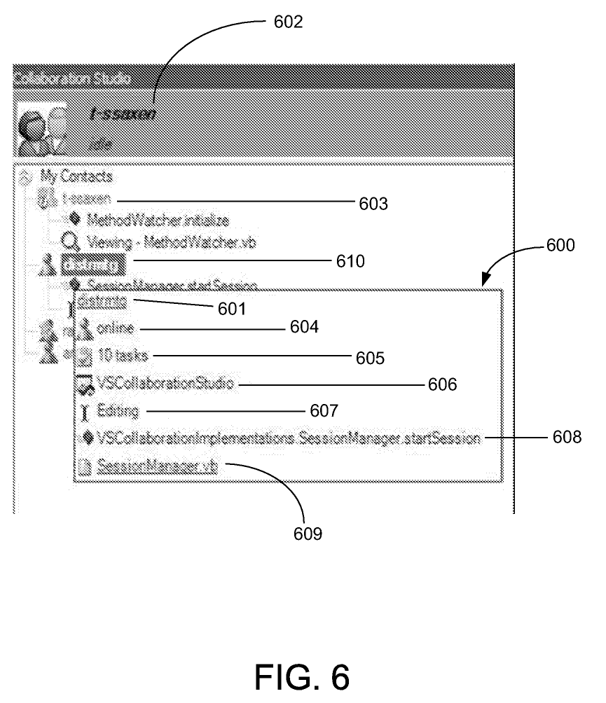

FIG. 5 shows another exemplary view of a GUI 500 used to present a user 501/502 with presence and activity information and associated interactive controls. The GUI 500 is also displayed inside the presence sector 301 of the exemplary layout 300 of FIG. 3. In this GUI 500 the user 501/502 selects the ID for another user 503 in order to determine more detail about the current activities of the user 503 or initiate a collaboration session with the user 503. Upon selecting the user ID 503 a pop-up sector 504 is displayed which provides the user 501/502 with a number of different options. To determine more detail about the current activities of the selected user 503, the user 501/502 would scroll down the pop-up sector 504 to the properties item 505 and select it. This action results in the display of a subsequent pop-up sector 600, an exemplary view of which is shown in FIG. 6. By way of example but not limitation, the following types of additional presence and activity information for the selected user ID 601/610 can be displayed to the user 602/603 via the pop-up sector 600: their current work status 604, the number of project tasks that are currently assigned to them 605, the applications within the IDE system and process they are currently using 606, the development methods they are currently using 607, and which functions 608 and files 609 they are currently working on.

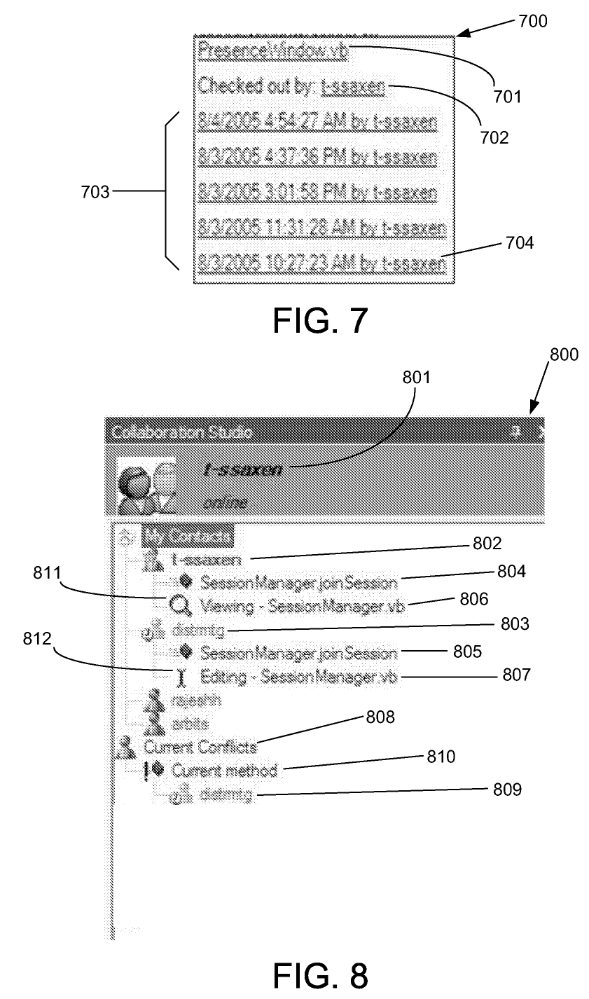

Referring again to FIG. 6, the user 602/603 can scroll down the pop-up sector 600 and select certain items displayed in it to determine further information about them. By way of example but not limitation, the user 602/603 can select a particular file 609 in the pop-up sector 600, after which another subsequent pop-up sector containing further information about the file would be displayed. FIG. 7 shows an exemplary view of this subsequent pop-up sector 700, which in this example, contains information such as the selected file name 701, which users currently have the file 701 checked-out 702, and the last “N” users 703 who previously checked-out/in the file 701. Although it is not shown, the user 602/603 can scroll down the pop-up sector 700 and select any of the items in the list 703 to view the specific changes that were previously made in the file (if any) on the date and time, and by the user displayed in the item that is selected (704 for example). Although the list 703 shows, by example but not limitation, that the file 701 was previously checked-out by the same user 704 that currently has the file checked-out 702, if there were other users that previously checked-out the file 701 they would also be shown in the list 703. Furthermore, if the file 701 was checked-out by more than one user at the same time, all users that had the file checked-out would be displayed 702.

Referring yet again to FIG. 6, although it is not shown, the user 602/603 can also determine more information about the tasks assigned to the selected user 601/610 (such as the types of tasks and their completion status, among other things) by scrolling through the pop-up sector 600 and selecting the user's ID 601.

As aforementioned, the IDE system and process of the present invention continually monitors the data contained in the presence and activity awareness information module 201 of FIG. 2 and communicates to users when, and how, the work they are currently doing may conflict with the current work of others, such as when multiple users are unknowingly working on the same code module, the same class or function, or dependent classes or functions at the same time, among other things. FIG. 8 shows an exemplary view of a GUI 800 used to present a user 801/802 with conflict information and interactive controls. The GUI 800 is also displayed inside the presence sector 301 of the exemplary layout 300 of FIG. 3. In this GUI 800 two different users 801/802 and 803 are working on the same function 804/805 and same file 806/807 at the same time. As a result, the GUI 800 displays to user 801/802 that there exists a current conflict situation 808. Underneath the current conflicts item 808 the GUI 800 informs user 801/802 that another user 809/803 is currently using the same method 810 as they are (i.e., both users are viewing or editing 811/812 the same function 804/805 and the same file 806/807 at the same time). In tested embodiments, activity conflicts are detected at the method and class or function level, such as if two team members are editing the same class or function in the same code module at the same time, or if they are editing two different classes or functions which are dependent on each other at the same time. However, other forms of activity conflict detection could also be implemented.

Referring again to FIG. 5, a user can initiate one of a number of different types of collaboration sessions with another user by selecting the user's ID 503, after which a pop-up sector 504 is displayed which provides the user 501/502 with a number of different collaboration session options. To start an audio-only conference session with the selected user 503, user 501/502 would scroll down the pop-up sector 504 to the start audio only conversation session item 506 and select it. To start an audio/video conference session with the selected user 503, user 501/502 would scroll down the pop-up sector 504 to the start audio video conversation session item 507 and select it.

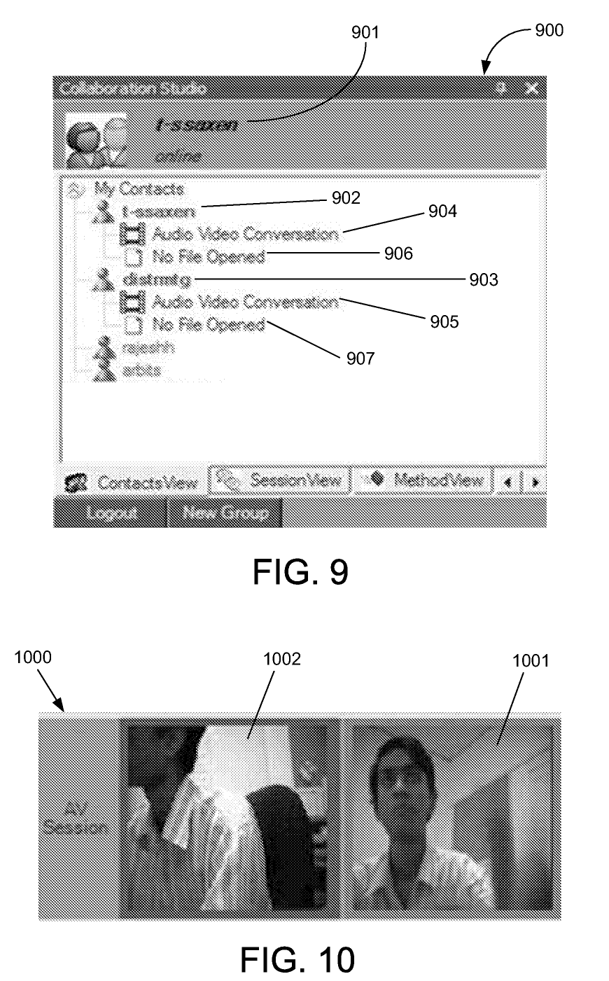

FIG. 9 shows an exemplary view of a GUI 900 used to present a user 901/902 with information and interactive controls associated with the aforementioned audio/video conference session that was started. The GUI 900 is displayed inside the presence sector 301 of the exemplary layout 300 of FIG. 3. In this GUI 900 the IDs for each user involved in the audio/video conference session 902 and 903 are displayed. Under each user ID 902/903 additional information associated with the current activities of each user at the time of the conference session is displayed including as shown in the exemplary GUI 900, but not limited to, the applications they are using 904/905 and the files they have open 906/907 that they are jointly sharing. In the example shown, if the two users 902/903 did have a file open for joint review or debug, the file name would be listed under each user's ID and contents of the file would be displayed inside the workspace sector 304 of the exemplary layout 300 of FIG. 3.

FIG. 10 shows an exemplary view of a GUI 1000 used to display the videos 1001 and 1002 associated with each user in the aforementioned audio/video conference session. The GUI 1000 is displayed inside the video sector 303 of the exemplary layout 300 of FIG. 3, in combination with the GUI 900 of FIG. 9 displayed in the inside the presence sector 301 of FIG. 3.

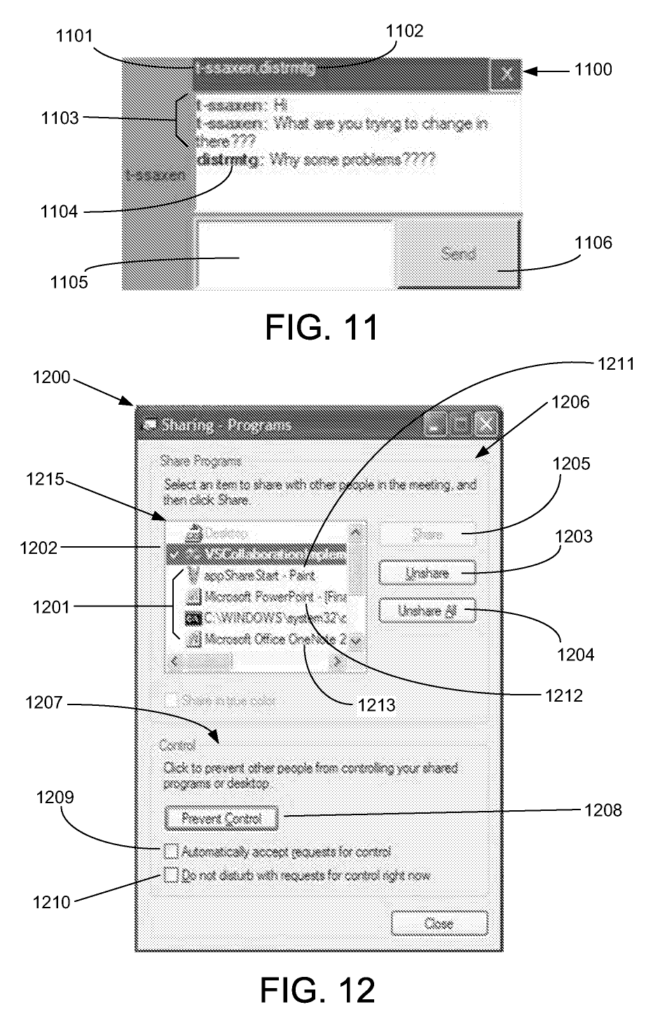

Referring yet again to FIG. 5, to start an interactive text chat session with the selected user 503, user 501/502 would scroll down the pop-up sector 504 to the start text chat conversation session item 508 and select it. FIG. 11 shows an exemplary view of a GUI 1100 used to display the text chat sector and related interactive controls for the session. The GUI 1100 is displayed inside the text chat sector 302 of the exemplary layout 300 of FIG. 3. The GUI 1100 operates in a fashion similar to existing chat GUIs where the user 1101 types the message they want to send 1103 into the box 1105 and hits the send button 1106. The other user 1102 receives the message displayed similarly in their text chat sector. In a similar fashion user 1102 types their response on their GUI and sends it. The user 1101 receives the other user's 1102 response 1104, and so on they can communicate back and forth.

Referring yet again to FIG. 5, to start an interactive application sharing session with the selected user 503, user 501/502 would scroll down the pop-up sector 504 to the start application sharing session item 509 and select it. FIG. 12 shows an exemplary view of a new sector that is automatically opened on the user's 501/502 display monitor containing a program sharing control GUI 1200. The share programs frame 1206, within the sharing control GUI 1200, allows the user 501/502 to select an application program to share with user 503 from a list of available application programs 1201. This list 1201 also indicates any programs that are currently being shared 1202 by displaying a check mark next to the program. The user 501/502 may choose to unshare an existing shared program by selecting it 1202 and then clicking the unshare button 1203. The user may also choose to unshare all existing shared programs by simply clicking the unshare all button 1204. To share a new application program with user 503, user 501/502 would scroll down the list 1201 and select the desired program. User 501/502 would then click the share button 1205 to complete the program sharing process, upon which the program would be opened on the display monitor of all users who are sharing the program (in this case, user 501/502 and user 503), either in the workspace sector 304 of the exemplary layout 300 of FIG. 3, or in a new window that is opened associated with the application program. By default, user 501/502 would be the only one who has possession and control of the newly shared program and user 503 can only view the program results. If user 503 desires to have control of the program they would have to formally request and be granted control from user 501/502. Via the control frame 1207, user 501/502 can optionally set a number of different parameters associated with their control of the program. For example, user 501/502 can opt to prevent anyone else from ever being able to request control of the program by clicking the prevent control button 1208. Alternatively, user 501/502 can automatically accept another user's 503 request for program control by checking the box 1209 labeled automatically accept requests for control. Further, user 501/502 can temporarily block requests for control by checking the box 1210 labeled do not disturb with requests for control right now (by way of example but not limitation, this would be useful if user 501/502 was using application sharing to give a lecture to other users).

Referring yet again to FIG. 5 and FIG. 12, to start and control an electronic whiteboard collaboration session the user 501/502 would follow the steps for interactive application sharing described above to select, share and control an application program from the list 1201 in the share programs frame 1206 that supports the desired whiteboard features and/or functionality such as drawing, text entry or editing, graphics display or editing, and/or image display or editing, among others. There are numerous choices of existing software programs available to computer users that provide these features.

Referring yet again to FIG. 5 and FIG. 12, to start a co-browsing session with the selected user 503, user 501/502 would scroll down the pop-up sector 504 to the start co-browse session item 510 and select it. A new sector would be automatically opened on the user's 501/502 display monitor containing a file sharing control GUI structured similarly to GUI 1200, the only differences being that the share programs frame 1206 would instead be called share files, and the list items in the scrollable sector 1215 would instead be candidate file names to be co-browsed (rather than candidate application program names to be shared). The user 501/502 would then follow the same steps as for interactive application sharing described above to select, share and control a file to be co-browsed. The file would be opened automatically, by the application program that originally created it, in the workspace sector 304, of the exemplary layout 300 of FIG. 3, on the display monitor of all users who are co-browsing the file (in this case, user 501/502 and user 503). By default, user 501/502 would be the only one who has possession and control of the file and its display characteristics, and user 503 can only view the file. Control of the shared file being co-browsed would be administered using the exemplary GUI within the control frame 1207, in the same fashion and using the same methods as described above for program control.

Contextual annotation of a file or other work item being co-browsed can be accomplished via using the text and/or graphical editing capabilities within the application program that opened the file. If no such capabilities exist within the application program, then contextual annotation (i.e. notes or drawings) can be accomplished outside the file itself by sharing a separate program that contains the desired text and/or graphical editing capabilities.

As aforementioned, it can be particularly effective for users to combine multiple types of interactive collaboration at the same time. By way of example but not limitation, in the lecture example given above a user could be giving a lecture by starting a session to co-browse slides in a presentation file. The sound of his voice could be broadcast during the lecture by also starting an audio-only conference session. Finally, he could broadcast notes or drawings he makes during the lecture by also starting an electronic whiteboard collaboration session. By way of further example, interactive text chatting is particularly useful when combined with other forms of collaboration such as co-browsing a software source code file during a code walkthrough, or other peer or management review of a software source code file.

The aforementioned types of collaboration sessions between users are provided by way of example but not limitation. Other forms collaboration that are popular in today's network and computer environments can also be integrated in light-weight form into the IDE system and process of the present invention and initiated via the pop-up sector 504 of FIG. 5.

### 3.0 Information Monitoring

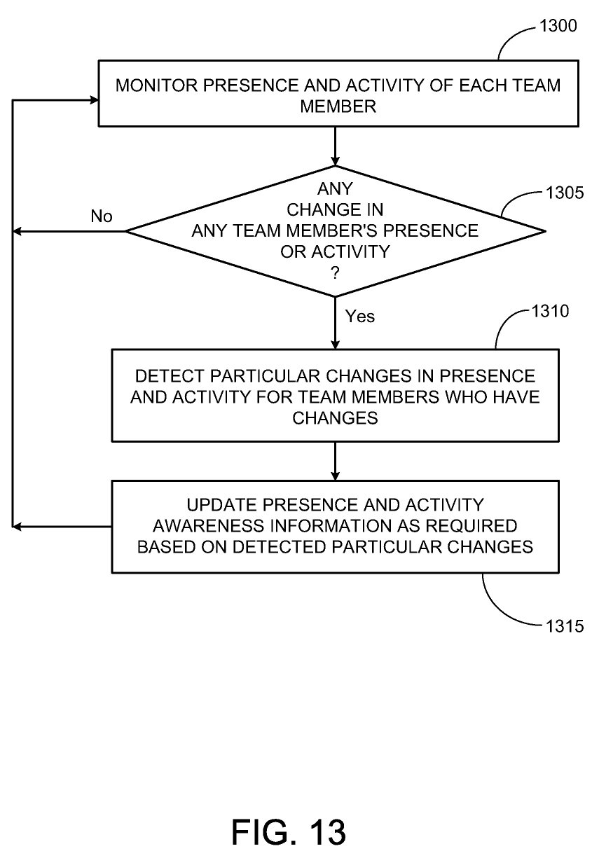

FIG. 13 shows an exemplary flow diagram depicting a process for monitoring the presence and activity of each user using the present collaborative IDE system and process. In addition, FIG. 13 also shows the related process for detecting changes in the user presence and activity, and updating the data in the presence and activity awareness information module 201 of FIG. 2 based on the changes. The process continuously monitors the presence and activity of each user using the system and process 1300 by performing distributed polling, across the network, of all the computers in the system. During the monitoring the process detects changes in the presence or activity of each user 1305. If a change is detected then the process further detects the particular, detailed changes in the user's presence and/or activity 1310 and updates the data in the presence and activity awareness information module 201 accordingly 1315, after which the process resumes monitoring the presence and activity of each user 1300.

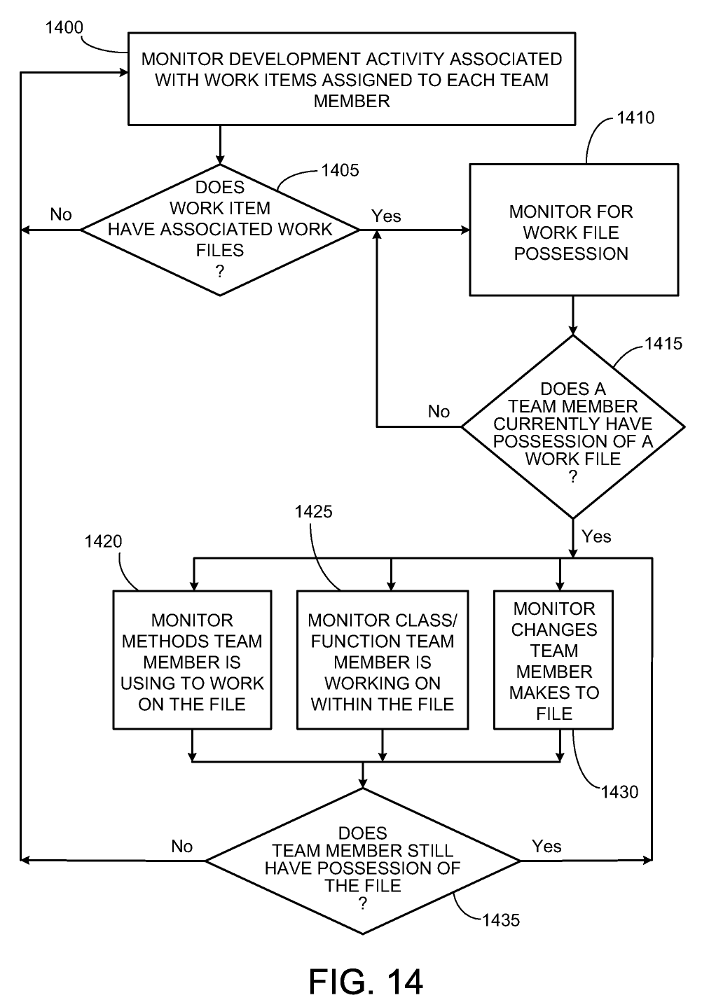

FIG. 14 shows an exemplary flow diagram depicting a process for monitoring activity associated with work items and their associated work files for each user using the present IDE system and process. The process continually monitors each user's activity associated with their assigned work items 1400. During this monitoring the process detects if each work item has work files associated with it 1405. For each work item that has work files associated with it, the process further monitors for work file possession 1410 and determines if a user currently has possession of a work file 1415 (i.e., the user currently has the work file checked-out of the SCCS). When a user currently has possession of a work file, the process further monitors the user's activity associated with the work file, including the methods the user is using to work on the file 1420, the class or function the user is working on within the file 1425, and the changes the user makes to the file 1430. The process further detects when a user relinquishes possession of a work file 1435, after which the process resumes monitoring each user's activity associated with their assigned work items 1400.

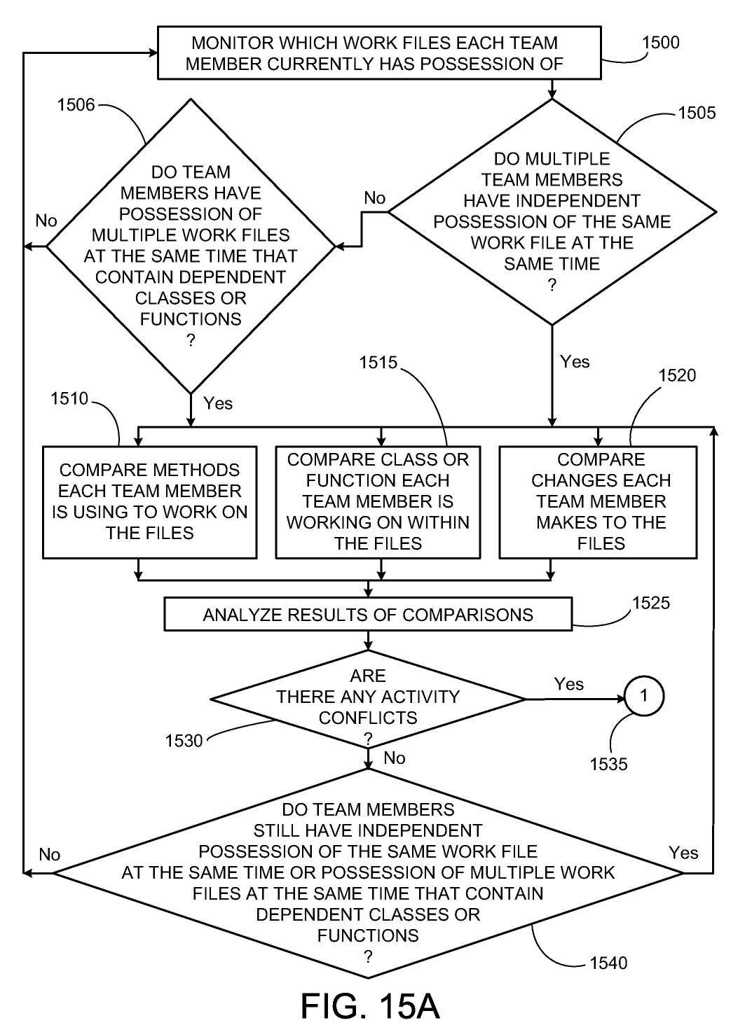

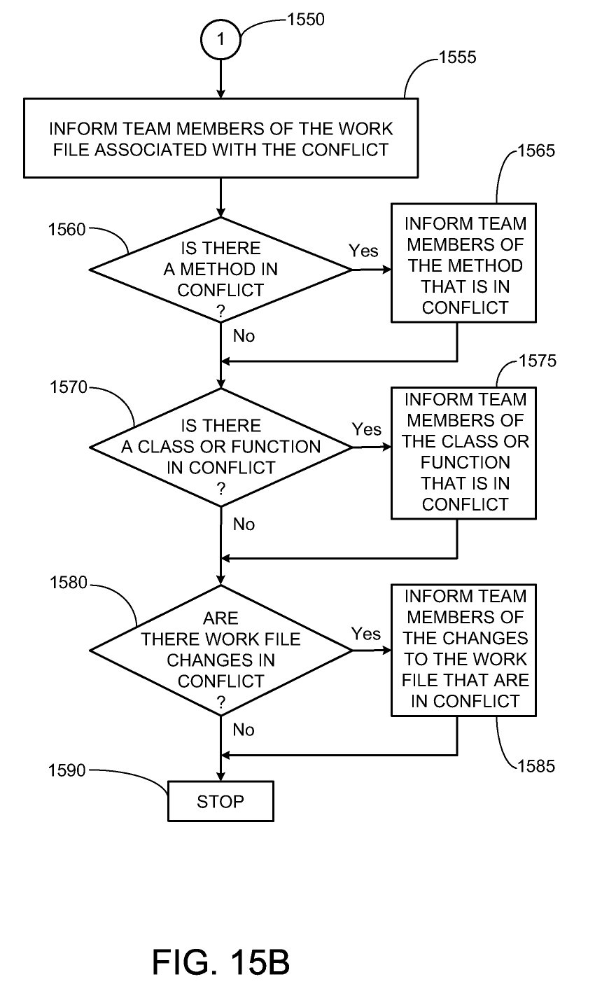

FIGS. 15A-B show an exemplary flow diagram depicting the process for monitoring which users using the present IDE system and process have possession of which work files, and their associated independent activity on the files. In addition, FIGS. 15A-B also show the related process for comparing and analyzing the activity for conflicts. The process continually monitors which work files each user currently has possession of 1500. During this monitoring, the process detects the cases where more than one user has independent possession of the same work file at the same time 1505, or where users have possession of multiple work files at the same time that contain dependent classes or functions 1506. If either of these cases is detected, the process further compares the work activity of each user on the work files, including comparing: the methods each user is using to work on the files 1510, the class or function each user is working on within the files 1515, and the changes each user makes to the files 1520. The process further analyzes the results of these activity comparisons 1525, and detects if there are any activity conflicts 1530. If no activity conflicts are detected, the process then detects if users still have independent possession of the same work file at the same time or if users still have possession of multiple work files at the same time that contain dependent classes or functions 1540. If they do, the process resumes comparing the activity of each user on the work files 1510, 1515, 1520 and analyzing the results of the comparisons 1525 for activity conflicts 1530.

If activity conflicts are detected in the aforementioned comparison of the activity of each user on the work file 1510, 1515, 1520, the process 1535 further informs the users of the conflicts 1550 as depicted in the exemplary process flow diagram shown in FIG. 15B. This process informs the users (who either independently have possession of, and are working on, the same work file at the same time, or have possession of, and are working on at the same time, multiple work files that contain dependent classes or functions) of the work file associated with the conflict 1555, and other information associated with the conflict such as: if there is a method in conflict 1560, the particular method that is in conflict 1565; if there is a class or function in conflict 1570, the particular class or function that is in conflict 1575; and if there are changes to the work file that are in conflict 1580, the particular changes that are in conflict 1585.

### 4.0 Additional Embodiments

While the present invention has been described in detail by specific reference to preferred embodiments thereof, it is understood that variations and modifications thereof may be made without departing from the true spirit and scope of the present invention. For example, in the preceding, a software product development project was used as the basis to describe the practice of the preferred embodiments of the present invention. However, the present invention is equally applicable to, and may also be practiced in, other types of development projects including, by way of example but not limitation: 1. Hardware development projects such as electronic circuits, printed circuit boards (PCBs) or printed circuit board assemblies (PCBAs), mechanical or structural components, enclosures and other types of mechanical packaging; 2. Semiconductor development projects such as integrated circuits (ICs) and application-specific integrated circuits (ASICs); 3. Embedded software development projects such as firmware and micro-code, among others; 4. Development projects that contain any combination of the aforementioned software, hardware, semiconductor development and/or embedded software. The present invention is also applicable to, and may be practiced in, other types of development projects that are not product related, such as a company developing their own information technology system or infrastructure, among many others.

Further, although the present invention has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A collaborative integrated development environment system, comprising:
a plurality of general purpose computing devices, each of which is connected to and communicates across a common communication network, and each of which comprises,
an integrated development environment user interface, and
a computer program having program modules executable by the computing device for an authorized development project team member, comprising,
a presence and activity awareness information module for providing presence and activity awareness information about each team member and their activity in a development project, and
an interactive collaboration tools module providing facilities for synchronous and asynchronous collaboration and information sharing between team members.

2. The system of claim 1, further comprising an authorization module for determining if a prospective user of the system is an authorized development project team member and therein is able to access and manipulate the presence and activity awareness information of the system or use the interactive collaboration tools of the system.

3. The system of claim 1, further comprising:
an audio input device for capturing audio of a team member;
an audio output device for playing audio transmitted to one of the computer devices, via the network, from another team member; and
wherein the computer program further comprises an audio program module for,
transmitting audio of the team member over the network to one or more other team members, and
receiving audio from one or more other team members transmitting audio over the network.

4. The system of claim 1, further comprising:
a video input device for capturing video of a team member;
wherein the computer program further comprises a video program module for,
transmitting video of a team member over the network to one ore more other team members, and
receiving video from one or more other team members transmitting video over the network.

5. The system of claim 1, wherein the presence and activity awareness information module comprises a sub-module for providing people presence data for team members, said data comprising:
information on the current work status and activities of the team members, comprising at least one of,
if a team member is currently working on the project or not,
whenever a team member is working on the project, if they are currently busy or idle, and whenever they are busy, which particular activities they are currently involved in,
number and types of project tasks they are assigned to complete, and
ways in which they can be contacted.

6. The system of claim 1, wherein the presence and activity awareness information module comprises a sub-module for providing session presence data for team members, said data comprising:
information on collaborative sessions between team members, comprising at least one of,
session types,
team members that are participating in each session, and
whether the session is open to other team members to monitor or join, or closed to other team members.

7. The system of claim 1, wherein the presence and activity awareness information module comprises a sub-module for providing project presence data for team members, said data comprising:
information on the progress of the development project, said information comprising at least one of,
work items and/or development project tasks assigned to each team member,
development status of each work item or task,
anomalies found in each work item thus far,
anomalies found in the overall project thus far, and
information specific to each anomaly comprising the associated work item, which team member it is assigned to and its resolution status.

8. The system of claim 1, wherein the presence and activity awareness information module comprises a sub-module for providing work item presence data for team members, said data comprising:
information on work items that are assigned to each team member, said information comprising at least one of,
which team members are currently working on which work items,
a work file associated with each work item,
which work files each team member currently has possession of and a class or function each team member is working on within said work files, and
changes that were previously made to each work file and which team members made them.

9. The system of claim 1, wherein the presence and activity awareness information module comprises a sub-module for providing contacts data for team members, said data comprising:
information on which team members are assigned to work on which aspects of the development project; and
information on the best team member to contact for a particular project topic.

10. The system of claim 1, wherein the interactive collaboration tools module comprises tools that utilize and interact with data in the presence and activity awareness information module, said tools comprising at least one of:
an audio conferencing tool to initiate and execute an audio-only conversation session between team members;
an audio/video conferencing tool to initiate and execute an audio/video conversation session between team members;
a text-based instant messaging tool to initiate and execute a text chat conversation session between team members;
a co-browsing tool to initiate and execute a co-browsing session between team members; and
an application program sharing tool to initiate and execute an application sharing session between team members, said application sharing session comprising the ability to instantiate a live electronic whiteboard session between team members.

11. The system of claim 10, wherein the co-browsing session comprises:
an ability for a team member to contextually annotate the work item being co-browsed; and
an ability for other team members involved in the session to see said annotations as they are made.

12. The system of claim 10, further comprising a program module for recording the proceedings and artifacts of a session, comprising at least one of:
recording audio of team members;
recording video of team members;
recording co-browsing sessions and annotations;
recording text chat conversation sessions; and
recording application sharing sessions.

13. The system of claim 10, further comprising a sub-module for administering possession and control of a shared application program, said sub-module comprising:
a determination and identification of which team member involved in the application sharing session currently has control of the program;
an ability for a team member, that does not currently have control of the program, to request control of the program; and
an ability for a team member that does have control of the program to either,
reject or block the other team member's request for control of the program, or
transfer control of the program to the other team member that requested it.

14. In a system comprising a plurality of computers connected to and communicating across a common communication network, a computer-implemented process for providing presence and activity awareness information for a development project team using the system, and interactive collaboration tools that facilitate collaboration and sharing of the information between team members using the system, comprising process actions for:
monitoring the presence and activity of each team member via distributed polling of the computers across the network;
detecting changes in said presence and activity; and
updating the information as required based on the changes.

15. The process of claim 14, wherein the process action of detecting changes in presence and activity of each team member comprises:
monitoring development activity associated with work items assigned to each team member, comprising at least one of,
monitoring which work files associated with which work items each team member currently has possession of, and
whenever a team member has possession of a work file, monitoring at least one of,
methods they are using to work on the file,
class or function they are working on within the file, and
changes they made to the file since acquiring possession.

16. The process of claim 15, wherein the process action of monitoring development activity associated with work items assigned to each team member, further comprises:
whenever one team member currently has possession of one instantiation of a work file, and another team member concurrently has possession of another, independent instantiation of the same work file, or whenever team members concurrently have possession of multiple work files that contain dependent classes or functions,
comparing the development activity of each team member associated with their independent instantiations of the file or files, said activity comprising at least one of,
methods they are using to work on the file or files,
class or function they are working on within the file or files, and
changes they made to the file or files since acquiring possession, and
analyzing the results of said comparison of development activity of each team member for activity conflicts.

17. The process of claim 16, wherein the process actions of comparing the development activity of each team member associated with their independent instantiations of a work file, or possession of multiple work files that contain dependent classes or functions, and analyzing the results of said comparison for activity conflicts, further comprises:
whenever an activity conflict exists, informing team members of the conflict comprising at least one of,
the work file associated with the conflict,
a method that is in conflict,
a class or function that is in conflict, and
changes to the work file that are in conflict.

18. A computer-readable medium having computer-executable instructions for providing, to development project team members, a collaborative integrated development environment distributed across a common communication network, said computer-executable instructions comprising:
collecting, monitoring and analyzing presence and activity awareness information about each team member and their activity in the development project;
providing said presence and activity awareness information to each of the team members; and
providing tools for interactive, synchronous and asynchronous, collaboration and information sharing between team members.
